(19) United States
(12) Patent Application Publication
(10) Pub. No.: US 2011/0047856 A1
(43) Pub. Date: Mar. 3, 2011

(54) EXPANDABLE FISHING LURE

(76) Inventor: Häkan Gustafsson, Bromma (SE)

(21) Appl. No.: 12/919,597

(22) PCT Filed: Feb. 27, 2009
(86) PCT No.: PCT/SE2009/000115

§ 371 Date: Nov. 18, 2010

(30) Foreign Application Priority Data
Feb. 28, 2008 (SE) 0800476-4
Mar. 12, 2008 (SE) 0800578-7

(51) Int. Cl. A01K 85/02; A01K 85/00

(52) U.S. Cl. 43/42.02; 43/42.41; 43/42.1

(57) ABSTRACT

The invention relates to a fishing lure (1) which comprises a profile element (5), which is expandable in water so that the fishing lure (1) has a low volume and weight on land, while at the same time giving a strong visual impression in water. The lure also comprises a solid carrier element (3) to which the expandable profile element (5), at least one fish hook (10) and a fastening device (12) for a towing line are attached.

### FIELD OF THE INVENTION

The present invention relates generally to fishing lures and more specifically to expandable fishing lures.

### BACKGROUND

A fishing lure is used when fishing with fishing rod and line. The fishing lures are usually designed to attract fish by the way they move in water and/or by their appearance, i.e. by its color and shape and possibly by glimmering or shining. In order to catch fish in a reliable way, the fishing lure also comprises one or more fish hooks.

A frequently used fishing lure is a spoon lure, which usually takes the form of a concave piece of metal. It attracts fish by shining and spinning, sinking in the water and moving randomly.

A wobbler is a fishing lure with a solid or hollow body that resembles a fish, made of light wood or plastic, typically equipped with two or three fish hooks. In the front of the wobbler's body there is a spoon—a small area with beak-like appearance that is angled downwards, flat or slightly curved.

Unlike the spoon lure, a wobbler does not move through the water by swirling, but by swinging, “wobbling”, back and forth sideways and sometimes up and down. The nature of the wobbling greatly affects the wobbler's ability to lure the fish to bite. Certain fish species are more drawn to the slow-wobbling wobblers, while other species are drawn to wobblers that oscillate back and forth with greater frequency. Also, the placement of the wobbler in the water attracts different types of fish, where some fish are drawn to wobblers that are close to the water's surface, while others are drawn more to wobblers that go deeper below the surface. The size and shape of the body and spoon as well as their angle in relation to one another determine the movement pattern and diving ability of the wobbler, and the wobbler's external appearance also varies depending on the type of fish that it is supposed to attract.

One important aspect in all types of fishing lures in terms of attracting fish is its size. Generally speaking, large hires can seem more attractive for large fish, and one has a larger chance of catching a large fish with a large lure. In spite of this, small lures are predominantly used seeing as these are easier to throw, create less air resistance and are easier to transport than large lures.

There is a need for the development of fishing lures that give a big impression and exercise a greater attraction power on the fish while simultaneously being easy to throw and transport.

### RELATED ART

It is for instance known through patent document U.S. Pat. No. 3,940,869 to provide an expanding fishing lure. This fishing lure is constructed of a soft, expanding, sponge-like material and lacks a solid element. This means that the lure lacks the controllability required to make the lure move in the desired pattern in the water.

Through patent document U.S.2004231225 A1 it is known to provide a fly fishing lure with a more solid element in the form of a tube, to which feathers and the like are attached. The fishing line is not attached directly to the lure but is pulled through the tube and attached on the other side to a fish hook that acts as a stopper so that the lure does not slip off the fishing line.

Through patent document JP2000295943A2 it is known to provide a fishing lure that has a firmer element to which an expanded elastic material is attached. The elastic material is applied to the lure during the manufacturing process, while the lure is in its expanded state.

It is also known for example through patent documents U.S. Pat. No. 4,492,054 and JP3103134 to provide wobblers that are hollow. Since these are manufactured in for example wood or metal, they are heavy and cannot be manufactured in larger sizes. In addition, these hollow wobblers can easily be perforated/“leak” when they come in contact with fish, rocks or the like and then become difficult to use.

### OBJECT OF THE INVENTION

The object of the present invention is to provide a solution to the problem of providing a fishing lure that makes a larger visual impression on the fish while simultaneously having a small weight and presenting relatively low air resistance when throwing.

### BRIEF DESCRIPTION OF THE DRAWINGS

The invention is explained further in the following description with references to the enclosed figures, where:

FIG. 1 shows a schematic picture of a fishing lure according to one embodiment of the invention;

FIG. 2 A-D shows wobblers according to several different embodiments of the invention;

FIG. 3 A-B shows further examples of fishing lures according to different embodiments of the invention.

### DETAILED DESCRIPTION

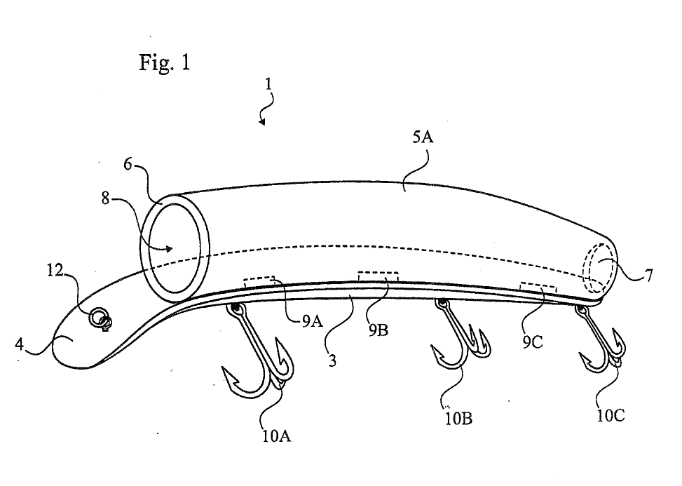

FIG. 1 shows a fishing lure (1) with a relatively solid carrier element (3) and an expandable profile element (5). The inventor has found that an expandable profile element (5) solves the problem of providing a fishing lure that makes a strong impression on the fish, while at the same time having a low volume and low weight on land. The expandable profile element (5) is folded or collapsed on land but expands when it is thrown into the water, so that its volume, area or profile creates a strong and attractive visual impression on the fish. The expandable profile element (5) is also inexpensive to manufacture and is not as sensitive to fish bites or other external damage, as its functionality would not be compromised even if the element (5) is for instance perforated.

The carrier element (3) functions as a support element to which fish hooks (10) can be attached, the expandable profile element (5) and a fastening device (12) for attachment of the towing line. It can also provide greater stability to the lure, which is essential for it to move in an adequate manner. The shape of the carrier element (3) affects the lure's movement pattern in the water to a considerable extent.

The carrier element (3) is made of a rigid material such as plastic, metal, wood or epoxy glue and may have different shapes. It can, for example, take the shape of a spoon lure, which has a concave and essentially oval, spoon-like shape, or it can take the shape of a wobbler, which has a more extended shape and includes of a wobbler spoon (4). Also the (4) shape, depth and the angle of the wobbler spoon (4) in relation to the rest of the carrier element (3) can be varied, depending on the desired movement pattern and depth of the wobbler.

The purpose of the expandable profile element (5) is thus to increase the fishing lure's attraction capability upon the fish, by providing a large volume, profile or area in water, and it may be shaped in various ways. In a preferred embodiment of the invention, it is designed as a tube (5A) with a front (8) and a rear (7) opening. The tube (5A) is made of a material that allows it to be in a folded mode when not in water, while it can be unfolded, or expanded, when it enters the water. The material can be fabric, for example a water-repelling fabric such as nylon, plastic, rubber or similar material. The expansion of the tube (5A) occurs when the fishing lure (1) is pulled through the water via the fastening device (12), whereby water flows in through the front opening (8), through the tube (5A) and out through the rear opening (7).

In order to facilitate water flow through the tube (5A), the front opening (8) can be reinforced by a rigidifying element (6). This element (6) ensures that the front opening (8) does not collapse by being kept in a constantly open position. The rigidifying element (6) may be shaped in various ways, e.g. circular, bow-shaped or V-shaped. It may also be attached to the carrier element (3) in such a way that the opening (8) is positioned at a certain angle to the carrier element (3) and/or to the spoon (4), so that water easily flows through the opening (8) when the lure is pulled by the fastening element (12).

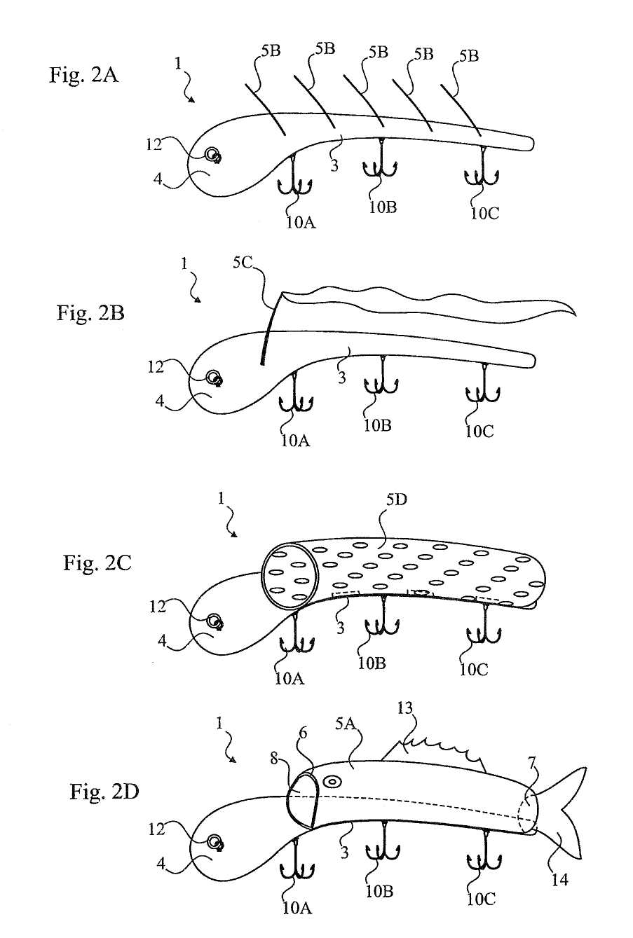

The expandable profile element (5) can also be designed in a variety of other ways. Some are illustrated in FIG. 2. FIG. 2A shows a design where the expandable profile element (5) comprises a number of relatively rigid and flexible elements, such as lamellas, sticks, rods, strips or heddles (5B), which are fastened to the carrier element (3) at an angle, preferably leaning towards the fastening device (12). Since the heddles (5B) are flexible, they will be pulled backwards when encountering water resistance when the fishing lure (1) is drawn through the fastening element (12). This leads to an expansion that gives the illusion of a body, surface or profile which can attract fish.

FIG. 2B shows another design in which the expandable profile element (5) comprises at least one relatively rigid element (5C), to which one or more pieces or strips of fabric, plastic, yam, soft metal or similar material is attached. The element (5C) ensures that the pieces or strips come up a bit from the carrier element (3), but the pieces or strips can also be fastened directly to the carrier element (3). Even this design gives the illusion of a body that can attract fish when it is cast into the water.

Yet another embodiment is shown in FIG. 2C where the expandable profile element (5) comprises a sponge- or sponge-like material (5D). The sponge (5D) can be squeezed and compressed to a very small volume when the fishing lure is not in use. When the lure (1) is cast into the water, the sponge (5D) soaks water and expands to several times its volume, thereby giving the impression of having a large body, which can attract fish.

FIG. 2D shows an embodiment of the invention where the expandable profile element (5) comprises a tube (5A), in accordance with the one described above. Fins (13, 14) may be attached to the tube (5A), further contributing to the desired movement pattern and providing the fishing lure (1) with a more fish-like appearance, in order to attract fish even more.

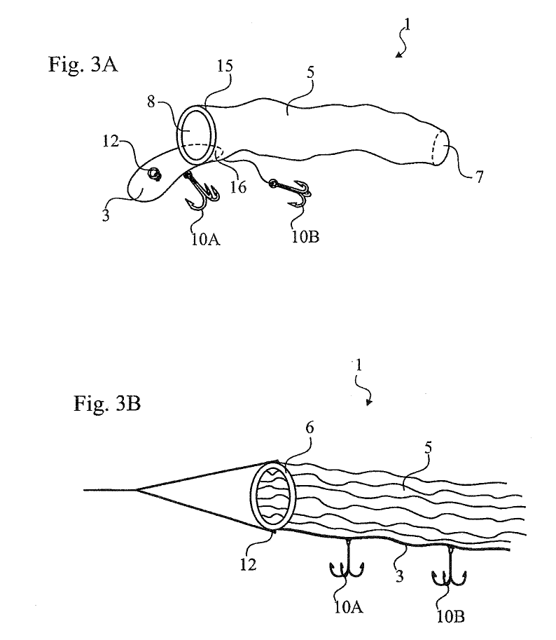

FIG. 3 shows further embodiments of the invention. In the embodiment shown in FIG. 3A, the carrier element (3), which is still deviced to attach hooks (10), the fastening device (12) and the expandable profile element (5), has a more oval and not as elongated design. The expandable profile element (5) is attached to the carrier element (3) in its front end (15), but hangs loosely behind the rear (16) of the carrier element (3). This allows for the profile element (15) to swing back and forth in a different manner in the water, thereby creating a new, exciting movement pattern that can attract certain fish species.

In the embodiment shown in FIG. 3B, the carrier element (3) comprises of a wire rope, a tube, a pipe or a narrow splint, possibly with a device that increases its weight. Hooks (10), fasteners (12) and an expandable profile element (5) are fastened to this carrier element (3), in accordance with the invention. In the example in the figure, the expandable profile element (5) is composed of a rigidifying element (6), to which tinsel, feathers, threads or strips of different materials such as plastic, fabric, leather, fur or rubber, or similar, are fastened. The rigidifying element (6) may be designed in various ways; it may for instance be circular, bow-shaped, or V-shaped and it may be attached to the carrier element (3) in a variety of ways.

The expandable profile element (5) may be attached to the carrier element (3) in either a fixed or detachable way. When the expandable profile element (5) is detachable from the carrier element (3), a attachment mechanism (9) between the profile element (5) and the carrier element (3) is required to enables this. The expandable profile element (5) can for example be detachable from the carrier element (3) by the two being attached to each other with Velcro. In this case, one part of the Velcro, for instance the part with the hooks, would be placed on the carrier element (3) and the complementary part with the loops would be placed on the expandable profile element (5). Another preferred attachment mechanism consists of a wedge-shaped device on the expandable profile element (5), which can be attached to a corresponding wedge-shaped slit in the carrier element (3). Other attachment mechanisms (9) that can be used, are for example push buttons, bayonet mount, snap lock, tape or hook devices.

When the expandable profile element (5) and the carrier element (3) are detachable from one other, it is easy to combine different embodiments of the carrier element (3) with various embodiments of the expandable profile element (5). For example may carrier elements (3) of varying length, shape or color be combined with expanding profile elements (5) of varying material, length, shape and color. One can also market various combinations of carrier elements (3) with different combinations of expandable profile elements (5) in different sets. It is also easy and inexpensive to replace a part (profile- or supporting element) should it break.

1. A fishing lure, comprising
a profile element that is expandable in water;
at least one fish hook;
a fastening device for attaching a towing line to, and
a carrier element to which the expandable profile element, the fish hook and the fastening device are attached;
wherein
the carrier element has an elongation which is parallel to the elongation of the profile element;
the profile element is arranged on the upper side of the carrier element, and
the fish hook(s) is (are) arranged on the underside of the carrier element.

2. The fishing lure according to claim 1, wherein the carrier element extends along the full length of the profile element.

3. The fishing lure according to claim 1, wherein the fishing lure is a wobbler, where the carrier element comprises a wobbler spoon whose size, concavity and angle determine how deep the wobbler will descend into the water.

4. The fishing lure according to claim 1, wherein the expandable profile element is designed as a tube arranged to expand when water streams through it.

5. The fishing lure according to claim 4, wherein the tube in its frontal end, closest to the fastening device, has a rigidifying element, which is attached to the carrier element in an angle which facilitates flow of water through the rigidifying element and the tube as the wobbler is drawn through the water via the fastening device.

6. The fishing lure according to claim 1, wherein the expandable profile element is configured with flexible heddles which are attached to the carrier element at such an angle that their attaching end leans towards the direction of movement when the fishing lure is drawn by the fastening device.

7. The fishing lure according to claim 1, wherein the expandable profile element is configured with at least one band that can be unfolded in water, which band is attached to the carrier element, or to a rigid element attached to the carrier element at a protruding angle.

8. The fishing lure according to claim 1, wherein the expandable profile element is configured with a sponge or sponge-like material, which expands when it comes into contact with water.

9. The fishing lure according to claim 1, wherein the carrier element and the expandable profile element, are detachably attached.

10. The fishing lure according to claim 9, wherein the carrier element and the expandable profile element are detachably attached via any of: Velcro; or push buttons; or a hooking device; or a wedge-shaped fastening device.

11. A carrier element intended for a fishing lure, comprising:
at least one fish hook, and;
a fastening device for attachment to a towing line;
wherein
the carrier element has an elongation and is devised with a first part of an attachment device, which is arranged to attach to a second part of the attachment device, where the first part of the attachment device is complementary to the second part and the second part is attached to an expandable profile element, and;
the first part of the attachment device is arranged on the upper side of the carrier element, and the fish hook(s) is (are) arranged on the underside of the carrier element.

12. The carrier element according to claim 11, wherein the first part of the attachment device comprises one of the parts of a Velcro attachment device; or one of the parts of a push button; or one of the parts of a hooking device; or one of the parts of a wedge-shaped fastening device.

13. An expandable profile element for a fishing lure, wherein the expandable profile element:
has an elongation, and
comprises a second part of an attachment device, arranged to attach to a first part of the attachment device, where the second part of the attachment device is complementary to the first part and the first part is attached to a carrier element,
wherein
the second part of the attachment device is devised along the elongation of the profile element, on the underside of the profile element.

14. The expandable profile element according to claim 13, wherein the second part of the attachment device comprises one of the parts of a Velcro attachment device; or one of the parts of a push button; or one of the parts of a hooking device; or one of the parts of a wedge-shaped fastening device.

15. The expandable profile element according to claim 13 or claim 13, comprising a tube that is arranged to expand when water streams through it.

16. The expandable profile element according to claim 15, wherein the tube one end has a rigidifying element which is arranged to keep an opening open for flow through of water.

17. The expandable profile element according to claim 13 or claim 13, comprising any of flexible heddles; or at least one band arranged to be unfolded in water; or a sponge or sponge-like material.
